(19) United States
(12) Patent Application Publication
(10) Pub. No.: US 2016/0315671 A1
(43) Pub. Date: Oct. 27, 2016

(54) NEAR FIELD COMMUNICATION ANTENNA TUNING BASED ON TEMPERATURE

(71) Applicant: BROADCOM CORPORATION, IRVINE, CA (US)

(72) Inventor: Philip Stewart Royston, Newbury (GB)

(73) Assignee: BROADCOM CORPORATION, IRVINE, CA (US)

(21) Appl. No.: 14/698,388

(22) Filed: Apr. 28, 2015

Related U.S. Application Data
(60) Provisional application No. 62/153,039, filed on Apr. 27, 2015.

(51) Int. Cl. H04B 5/02; G06Q 20/32; H04W 4/00

(52) U.S. Cl. CPC H04B 5/02; H04W 4/008; G06Q 20/3278; H04W 88/06

(57) ABSTRACT

A wireless device includes a Near Field Communication (NFC) interface, a NFC antenna, ferrite shielding, NFC antenna tuning circuitry coupled to the NFC interface and to the NFC antenna, and processing circuitry. The processing circuitry receives temperature input from a temperature sensor that is indicative of a temperature of at least one of the NFC antenna or the ferrite shielding, determines at least one NFC antenna tuning setting based upon the temperature input and configures the NFC antenna tuning circuitry based upon the at least one NFC antenna tuning setting. The NFC antenna tuning circuitry may include a plurality of lumped circuit elements including at least one controllable capacitance or inductance. The temperature sensor may be stand alone, included with the NFC interface, included with a battery, included with the processor, included with another wireless interface of the wireless device, or included with another component of the wireless device.

### CROSS REFERENCE TO RELATED PATENTS/PATENT APPLICATIONS

The present U.S. Utility Patent Application claims priority pursuant to 35 U.S.C. §119(e) to U.S. Provisional Application No. 62/153,039, entitled “NEAR FIELD COMMUNICATION ANTENNA TUNING BASED ON TEMPERATURE,” filed Apr. 27, 2015, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND

1. Technical Field

This disclosure relates generally to wireless communications and more particularly to devices and components thereof that support near field communications.

2. Description of Related Art

Communication systems are known to support wireless and wire lined communications between wireless and/or wire lined communication devices. Such communication systems range from national and/or international cellular telephone systems to the Internet to point-to-point in-home wireless networks to radio frequency identification (RFID) systems to radio frequency radar systems. Each type of communication system is constructed, and hence operates, in accordance with one or more communication standards. For instance, radio frequency (RF) wireless communication systems may operate in accordance with one or more standards including, but not limited to, RFID, IEEE 802.11x, Bluetooth, global system for mobile communications (GSM), code division multiple access (CDMA), WCDMA, local multi-point distribution systems (LMDS), multi-channel-multi-point distribution systems (MMDS), LTE, WiMAX, and/or variations thereof.

Near Field Communications (NFCs) relate to a set of communication standards that support short distance communications, e.g., 0 to 5 centimeters, between serviced devices, e.g., smart phones, payment terminals, data tags, and other NFC enabled devices. NFC devices support swiped proximity payments (such as paying with a smart phone), sharing of contact and other information simply by touching devices together, simplified setup of devices for communications via Wi-Fi or Bluetooth, and communications between an NFC enabled device and an unpowered NFC chip that is call a tag.

NFC communications are typically serviced in a frequency range around 13.56 MHz, which has a corresponding wavelength of approximately 22 meters. NFC devices are not large enough to support antennas with more than a very small percentage of this wavelength. Thus, in effect, NFC enabled devices communicate with one another using inductive coupling. Because of this, NFC devices must be in close proximity to one another in order to communicate, NFC communications provide benefits for privacy concerns.

An NFC device, acting as an NFC reader, detects a tag by polling with its carrier on for between 5 milliseconds for type A and 20 ms for Type F, after which case a polling command is sent and a response is then waited for and demodulated. The NFC reader drives a voltage onto its NFC antenna interface and detects the variation in the NFC antenna current caused by the target tag's load modulation response. In low power tag detection mode the NFC reader looks for a slower perturbation of the drive current caused by the tag entering and loading the field. The NFC reader antenna interface gain is traditionally set to a fixed value, which is a compromise between a maximum gain possible for a poorly tuned NFC antenna and maximum gain which would saturate receive path components in a well-tuned antenna system. It is also a compromise for the process corners of the NFC reader silicon set to avoid saturation/clipping. Improper tuning of the NFC antenna causes poor NFC communications and inefficient operations.

### BRIEF DESCRIPTION OF THE SEVERAL VIEWS OF THE DRAWING(S)

FIG. 1 is a system diagram illustrating a wireless communication system having wireless devices constructed according to the present disclosure;

FIG. 2 is a block diagram illustrating a wireless device constructed according to the present disclosure;

FIG. 3A is a diagram illustrating a structure of a Near Field Communication (NFC) antenna and ferrite shielding constructed according to the present disclosure;

FIG. 3B is a block diagram illustrating the structure of FIG. 3A residing upon a battery according to the present disclosure;

FIG. 4 is diagram illustrating NFC antenna resonance versus temperature for an NFC antenna that is backed by a ferrite material according to the present disclosure;

FIG. 5 is diagram illustrating an NFC interface, NFC antenna tuning circuitry, and an NFC antenna according to the present disclosure; and

FIG. 6 is a flow chart illustrating an embodiment of operations of a wireless device according to the present disclosure.

### DETAILED DESCRIPTION

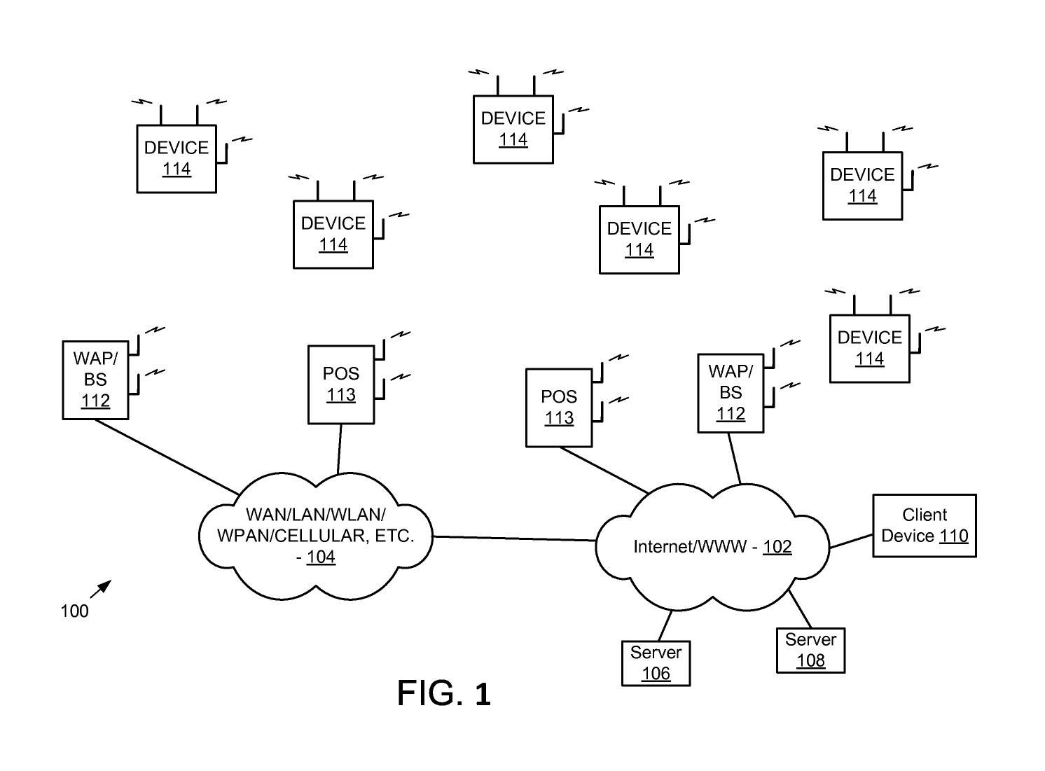

FIG. 1 is a system diagram illustrating a wireless communication system 100 having wireless devices constructed according to the present disclosure. The wireless communication system includes a plurality of communication networks 104 that couple to the Internet/WWW 102 to service voice and data communications. Coupled to the Internet/WWW 102 are servers 106 and 108 and at least one client device 110. The plurality of communication networks 104 includes one or more of a Wide Area Network (WAN), a Local Area Network (LAN), a Wireless Local Area Network (WLAN), a Wireless Personal Area Network (WPAN), a cellular network, and may include various other types of networks as well.

The plurality of communication networks 104 service one or more Wireless Access Points (WAPs) or base stations 112 that provide wireless service within respective service areas. WAPs provide wireless access service in respective service areas within servicing frequency bands, e.g., 2.4 GHz, 5 GHz, 60 GHz, etc., and support standardized (or proprietary) operating standards, e.g., IEEE 802.11x, Bluetooth, or other operating standards. Base stations, generally, provide wireless access service in respective service areas within respective frequency bands according to one or more cellular communication standards, e.g., GSM, LTE, xLTE, etc. In any case, these devices 112 provide voice and data service to a plurality of wireless devices 114, which will be described further herein. Some of these devices 112 may provide a combination of cellular, Wireless Wide Area Network (WWAN), Wireless Local Area Network (WLAN), and Wireless Personal Area Network (WPAN) service.

Further included with the system is a plurality of Point of Sale (POS) devices 113 that support wireless financial transactions with the wireless devices 114. These POS devices 113 may be located at checkout stations of stores, co-located with gas pumps, located at Automated Transaction Machines (ATMs), or at other locations at which financial transactions may be supported wirelessly. Examples of such functionality include Apple Pay, Pay Pal, etc.

Wireless devices 114 service wireless communications with the wireless access points/base stations 112, POS devices 113, and/or directly with one another. These wireless devices 114 may be found in various contexts, including the home, business, public spaces, and automobile. These wireless devices 114 may be cell phones, smart watches, watch phones, tablet computers, POS devices, readers, laptop computers, desktop computers, video games, automobiles, media players, digital cameras, smart phones, musical instruments, microphones, climate control systems, intrusion alarms, audio/video surveillance or security equipment, network attached storage, pet tracking collars, or other devices. As additional examples, the wireless devices 114 may further include audio head ends or DVD players, satellite music transceivers, noise cancellation systems, voice recognition systems, navigation systems, alarm systems, engine computer systems, set top boxes, remote controls, or other devices.

According to present disclosure, one or more of these wireless devices 114 support Near Field Communications (NFC). In supporting NFCs, the wireless devices 114 may operate as an NFC reader, an NFC card emulator, and/or in a peer-to-peer NFC mode. As a reader, the wireless devices 114 read data from a tag that supports NFC communications. As a tag, the wireless devices 114 support the exchange of data with a reader. In a peer-to-peer mode, the wireless devices 114 support the exchange of small amounts of data such as web addresses, business addresses, contact information, and/or other with other devices 114. In one embodiment, the wireless devices 114 support NFC communications at a target frequency of 13.56 MHz. However, this frequency range may differ in other embodiments.

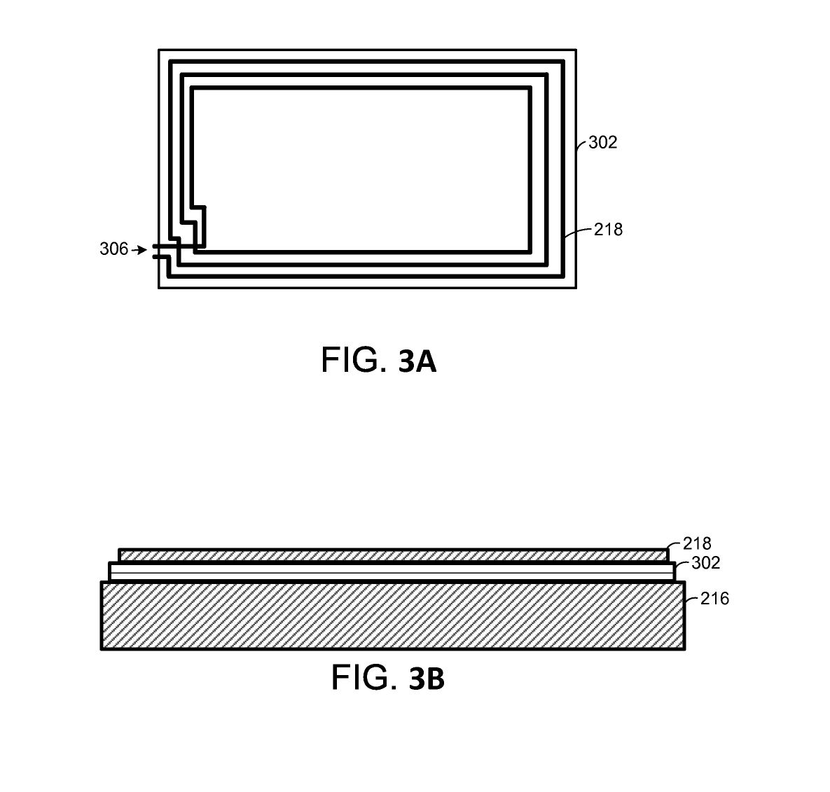

With most of the wireless devices 114, space for NFC antennas is limited. Thus, as will be described further with reference to FIGS. 3A and 3B, NFC antennas of the devices 114 are typically mounted on a largest available space within the wireless devices 114, which are often the flat surfaces of batteries of the devices 114. According to the present disclosure, the NFC antennas of the wireless devices 114 are separated by a ferrite material from the batteries or metallic chassis or PCB components of the phone. The ferrite material provides some isolation between the battery or other metallic phone components such as the PCB or chassis, and the field generated by the NFC antenna which increases the efficiency of the antenna above that which would be possible without the ferrite. In order to optimize the NFC performance of the wireless devices 114 it is desirable to tune the NFC antennas so that they are as efficient as possible. Some types of ferrite used to isolate the NFC antennas from the other components of the wireless devices 114 have a pronounced linear frequency response over temperature. In very warm or very cool ambient temperatures the offset caused by the ferrite results in a poorly tuned NFC antenna, causing NFC antenna gain to be much less than optimal.

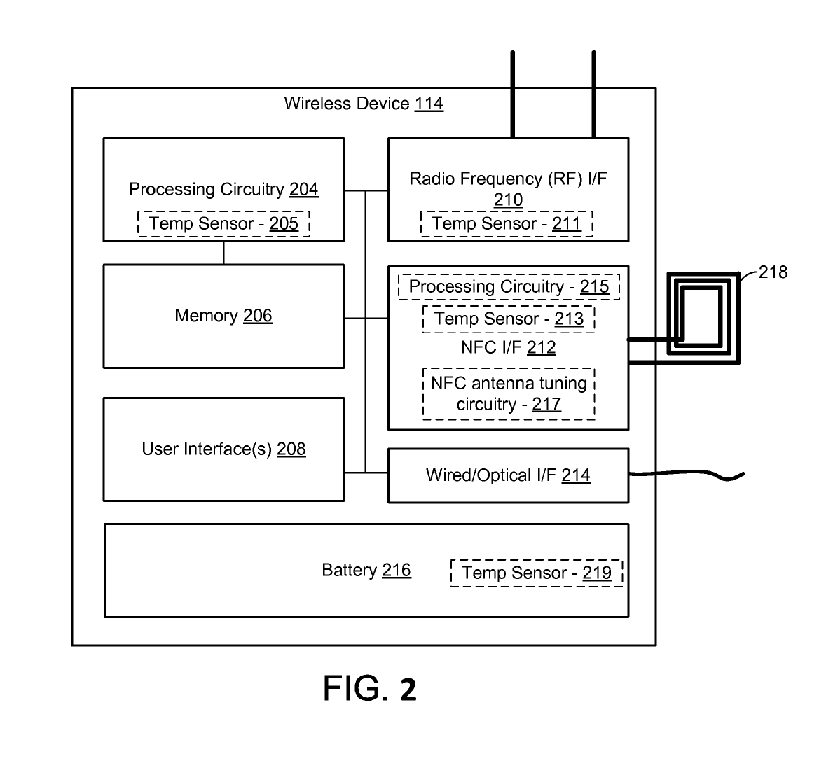

Thus, according to the present invention, at least one of the devices 114 includes an NFC an interface, an NFC antenna, ferrite shielding disposed adjacent the NFC antenna, and NFC antenna tuning circuitry coupled to the NFC interface and to the NFC antenna. The device 114 further includes processing circuitry that is configured to receive temperature input indicative of a temperature of at least one of the NFC antenna or the ferrite shielding, determine at least one NFC antenna tuning setting based upon the temperature input, and configure the NFC antenna tuning circuitry based upon the at least one NFC antenna tuning setting. The tuning may be performed at startup, at reset, upon exiting an idle mode of the NFC interface, upon a predetermined change in temperature of the NFC antenna or ferrite shielding, or upon another event. Further aspects of this structure and its operations will be described further with reference to FIGS. 2-6.

FIG. 2 is a block diagram illustrating a wireless device 114 constructed according to the present disclosure. The wireless device 114 includes processing circuitry 204, memory 206, one or more user interfaces 208, a Radio Frequency (RF) interface 210, a NFC interface 212, a wired/optical interface 214, and a battery 216. The wireless device 114 may be one of the wireless devices 114 illustrated in FIG. 1.

The processing circuitry 204 may be one or more of a microprocessor, a digital signal processor, application specific processing circuitry, and/or other circuitry capable of executing logic operations based upon pre-programmed instructions or the execution of software instructions. The memory 206 may be dynamic RAM, static RAM, flash RAM, ROM, EEPROM, programmable ROM, magnetic storage, optical storage or other storage that is capable of storing instructions and data. The stored data may be NFC antenna tuning data, audio data, video data, user data, software instructions, configuration data, or other data. The user interface 208 supports one or more of a video monitor, a keyboard, an audio interface, or other user interface device.

The RF interface 210 supports one or more of cellular communications, WLAN communications, WPAN communications, WWAN communications, 60 GHz (MMW) communications, NFC communications, and/or other wireless communications. These wireless communications are standardized in most embodiments and proprietary in other embodiments. The NFC interface 212 couples to NFC antenna 218 and supports NFC communications as will be further described herein. The wired/optical interface 214 supports wired communications, which may be LAN communications, WAN communications, cable network communications, direct data link communications, or other wired communications and/or supports optical communications, which are standardized in some embodiments and proprietary in other embodiments.

Multiple of the components 204, 206, 208, 210, 212, and 214 of the communication device may be constructed on a single integrated circuit die. It is fairly common to form all communication components, e.g., RF interface 210, NFC interface 212, and wired/optical interface 214 on a single integrated circuit. In some cases, even the antennas supporting the RF interface 210 may be formed on a single integrated circuit. In other cases, some or all of the components of the wireless device 114 may be formed on a Printed Circuit Board (PCB).

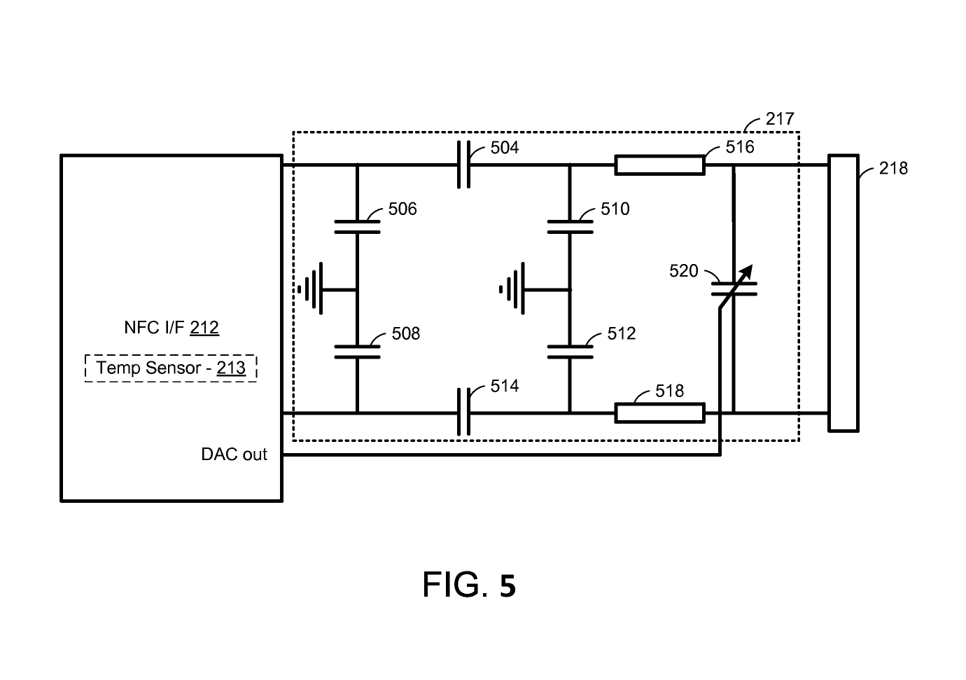

According to present disclosure, ferrite shielding is disposed adjacent the NFC antenna 218 and the NFC interface 212 includes NFC antenna tuning circuitry 217 that couples to the NFC antenna 218. Processing circuitry, which may be processing circuitry 204 or 215 is configured to receive temperature input indicative of a temperature of at least one of the NFC antenna 218 or the ferrite shielding, determine at least one NFC antenna tuning setting based upon the temperature input, and configuring the NFC antenna tuning circuitry 217 based upon the at least one NFC antenna tuning setting. The NFC antenna tuning circuitry 217 may include a plurality of lumped circuit elements including at least one controllable capacitance, which will be illustrated in FIG. 5 and described therewith.

The wireless device 114 further includes at least one temperature sensor configured to produce the temperature input. In one embodiment, the temperature sensor 213 is included with the NFC interface 212 and produces the temperature input. In another embodiment, the battery 216 includes a temperature sensor 219 configured to produce the temperature input. In still another embodiment, the RF interface 210 includes the temperature sensor 211, which produces the temperature input. In still a further embodiment, the processing circuitry 204 includes the temperature sensor 205.

FIG. 3A is a diagram illustrating a structure of a Near Field Communication (NFC) antenna and ferrite shielding constructed according to the present disclosure. With the structure of FIG. 3A, the NFC antenna 218 is disposed upon ferrite shielding 302. The NFC antenna 218 includes antenna inputs/outputs 306, which couple to the NFC interface 212.

FIG. 3B is a block diagram illustrating the structure of FIG. 3A residing upon a battery according to the present disclosure. The NFC antenna 218 is formed on the ferrite shielding 302, which resides upon the battery 216. In many implementations the NFC Antenna 218 is made of etched copper on a substrate such as FR4 or Kapton which is bonded to the ferrite shielding, this ferrite-antenna assembly is then bonded to the battery. This structure may be employed in any of the wireless devices 114 of FIG. 1.

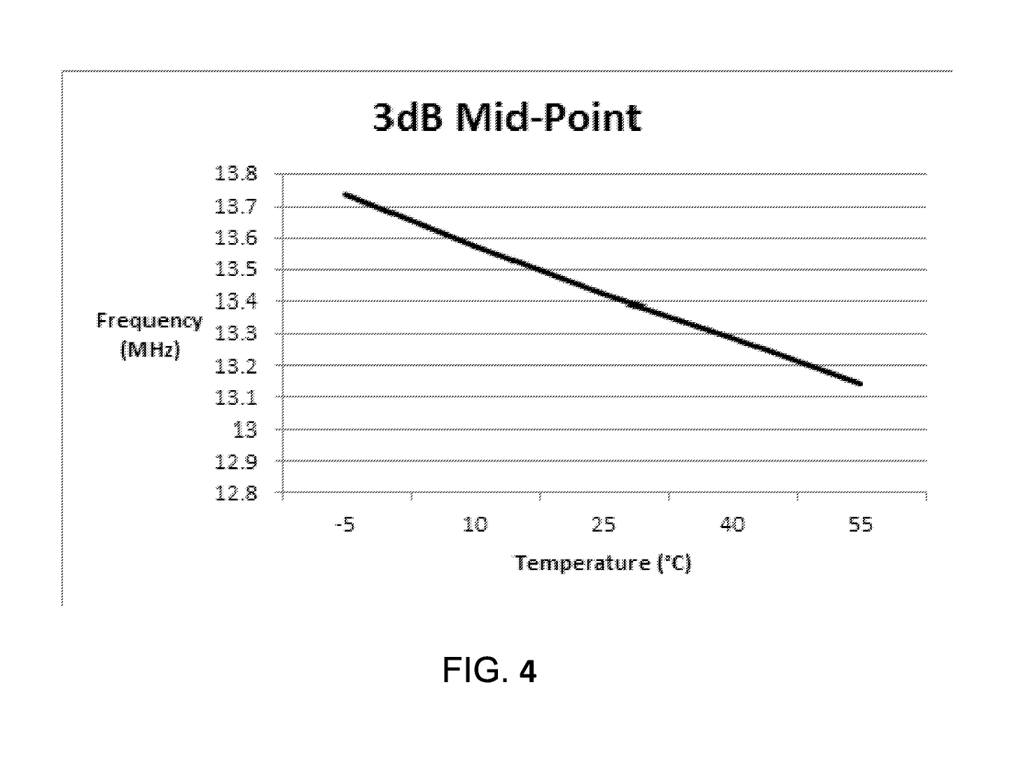

FIG. 4 is diagram illustrating NFC antenna resonance versus temperature for an NFC antenna that is backed by a ferrite material according to the present disclosure. As shown, the 3 dB Mid-Point of the resonance of the ferrite backed NFC antenna 218 varies with temperature. Thus, according to the present invention, NFC antenna tuning circuitry 217 is employed to tune the NFC antenna 218 for improved performance, such tuning depending upon measured temperature.

FIG. 5 is diagram illustrating an example NFC interface 212, NFC antenna tuning circuitry 217, and an NFC antenna 218 according to the present disclosure. With the embodiment of FIG. 5, the NFC antenna tuning circuitry 217 is shown to be separate from the NFC interface 212. However, in some embodiments, as shown in FIG. 2, the NFC antenna tuning circuitry 217 may be formed with the NFC interface 212. Further, the temperature sensor 213 may be formed with the NFC interface 212, separately, or with other components as described with reference to FIG. 2.

The NFC antenna tuning circuitry 217 includes a plurality of lumped circuit elements including at least one controllable capacitance 520. With the embodiment of FIG. 5, the lumped circuit elements include capacitors 504, 506, 508, 510, 512, and 514. The NFC antenna tuning circuitry 217 may also include lumped circuit elements 516 and 518, which may be capacitors or inductors. The controllable capacitance 520 is controlled by a Digital to Analog Converter (DAC) output of the NFC interface 212. The NFC interface 212 (processing circuitry contained therewith or other processing circuitry) may include a plurality of pre-determined control settings for the controllable capacitance with the processing circuitry selecting settings based upon the temperature input. In other embodiments, other components of the NFC antenna tuning circuitry 217 are controllable with control settings selected therefore based upon the temperature input. In other embodiments, one or more tuning elements are controllable inductors. Further in still other embodiments, both controllable capacitances and controllable inductances may serve as tuning elements for the NFC antenna tuning circuitry 217. Further, in other embodiments, differing types of control circuitry may be used to control the controllable capacitance 520 (or inductance). Examples of such controllable tuning elements are Pulse Wave Modulated (PWM) controlled inductors or capacitors. With this embodiment, the NFC interface 212 sends a PWM pulse stream, which serves to control capacitance or inductance of one or more tuning elements of the NFC antenna tuning circuitry 217.

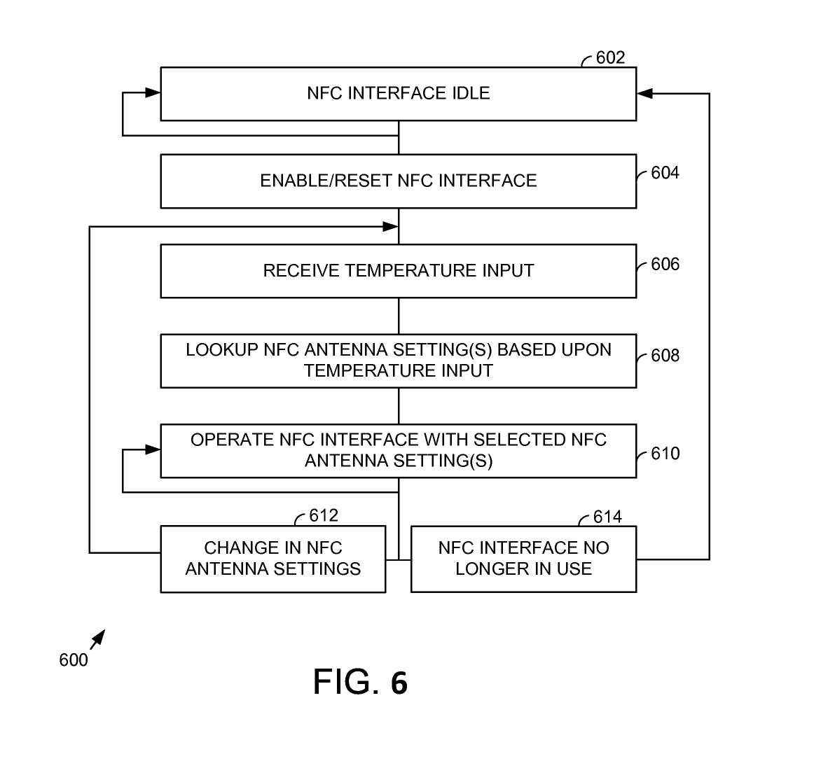

FIG. 6 is a flow chart illustrating an embodiment of operations of a wireless device according to the present disclosure. Operations 600 commence with the NFC interface in an idle state (Step 602). The idle state of Step 602 may have the NFC interface powered down, in a sleep mode, or awaiting a command to become active. From Step 602, the NFC interface is enabled or reset (Step 604). Once reset, operations 600 include receiving temperature input indicative of a temperature of at least one of the NFC antenna or ferrite shielding located adjacent the NFC antenna (Step 606). The processing circuitry of the NFC interface, or other processing circuitry, then determines at least one NFC antenna tuning setting based upon the temperature input (Step 608). Such selection may be by performing a look up from memory. Operations 600 continue with the NFC interface configuring the NFC antenna tuning circuitry based upon the at least one NFC antenna tuning setting and operating with such settings (Step 610).

Operations continue at Step 610 until it is determined that the NFC antenna tuning settings are to be changed (Step 612) from which operation returns to Step 606. Further, operations continue at Step 610 until it is determined that the NFC interface is no longer in use (Step 614) or needed from which operation returns to Step 602. The operations 600 of FIG. 6 are repeated in a continuing fashion so long as the wireless device is powered and functional. The operations 600 of FIG. 6 and the wireless devices 114 of FIG. 1 may include servicing a financial transaction via the NFC interface.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with,” includes direct and/or indirect coupling of separate items and/or one item being embedded within another item.

As may also be used herein, the term processing circuitry may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing circuitry may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing circuitry includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing circuitry implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing circuitry, and/or processing unit executes, hard coded and/or operational instructions corresponding to at least some of the steps and/or functions illustrated in one or more of the FIGs. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof. In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from FIG. to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a FIG. of any of the FIGs. presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

While particular combinations of various functions and features of the one or more embodiments have been expressly described herein, other combinations of these features and functions are likewise possible. The present disclosure is not limited by the particular examples disclosed herein and expressly incorporates these other combinations.

1. A wireless device comprising:
a Near Field Communication (NFC) interface;
a NFC antenna;
ferrite shielding disposed adjacent the NFC antenna;
NFC antenna tuning circuitry coupled to the NFC interface and to the NFC antenna; and
processing circuitry configured to:
receive temperature input indicative of a temperature of at least one of the NFC antenna or the ferrite shielding;
determine at least one NFC antenna tuning setting based upon the temperature input; and
configure the NFC antenna tuning circuitry based upon the at least one NFC antenna tuning setting.

2. The wireless device of claim 1, wherein the NFC antenna tuning circuitry comprises a plurality of lumped circuit elements including at least one controllable capacitance or inductance.

3. The wireless device of claim 1, further comprising a temperature sensor configured to produce the temperature input.

4. The wireless device of claim 3, wherein the temperature sensor is included with the NFC interface.

5. The wireless device of claim 1, further comprising a battery, wherein the ferrite shielding is disposed between the battery and the NFC antenna.

6. The wireless device of claim 5, wherein the battery includes a temperature sensor configured to produce the temperature input.

7. The wireless device of claim 1, further comprising:
Radio Frequency (RF) transceiver circuitry configured to support at least one of cellular, Wireless Local Area Network (WLAN), or Wireless Personal Area Network (WPAN) communications; and
a temperature sensor configured to produce the temperature input included with the RF transceiver circuitry.

8. A method for operating a wireless device comprising:
enabling a Near Field Communication (NFC) interface that couples to at least one of an NFC antenna or NFC antenna tuning circuitry;
receiving temperature input indicative of a temperature of at least one of the NFC antenna or ferrite shielding located adjacent the NFC antenna;
determining at least one NFC antenna tuning setting based upon the temperature input; and
configuring the NFC antenna tuning circuitry based upon the at least one NFC antenna tuning setting.

9. The method of claim 8, wherein configuring the NFC antenna tuning circuitry based upon the at least one NFC antenna tuning setting comprises setting at least one adjustable element of a plurality of lumped circuit elements.

10. The method of claim 8, further comprising receiving the temperature input from a temperature sensor.

11. The method of claim 10, wherein the temperature sensor is included with at least one of the NFC interface, the NFC antenna, the NFC tuning circuitry, an RF transceiver, or a battery of the wireless device.

12. The method of claim 8, wherein determining at least one NFC antenna tuning setting based upon the temperature input occurs at one or more of:
startup;
reset; or
upon exiting an idle mode.

13. The method of claim 8, further comprising servicing a financial transaction via the NFC interface.

14. A wireless device comprising:
a Near Field Communication (NFC) interface;
a NFC antenna;
ferrite shielding disposed adjacent the NFC antenna;
a temperature sensor;
NFC antenna tuning circuitry coupled between the NFC interface and the NFC antenna; and
the NFC interface further including processing circuitry configured to:
receive temperature input from the temperature sensor indicative of a temperature of at least one of the NFC antenna or the ferrite shielding;
determine at least one NFC antenna tuning setting based upon the temperature input; and
configure the NFC antenna tuning circuitry based upon the at least one NFC antenna tuning setting.

15. The wireless device of claim 14, wherein the NFC antenna tuning circuitry comprises a plurality of lumped circuit elements including at least one controllable capacitance.

16. The wireless device of claim 15, where the NFC interface further comprises a control output configured to produce a control signal coupled to the at least one controllable capacitance or inductance.

17. The wireless device of claim 14, further comprising a battery, wherein the ferrite shielding is disposed between the battery and the NFC antenna.

18. The wireless device of claim 17, wherein the battery includes the temperature sensor.

19. The wireless device of claim 14, further comprising:
Radio Frequency (RF) transceiver circuitry configured to support at least one of cellular, Wireless Local Area Network (WLAN), or Wireless Personal Area Network (WPAN) communications; and
a temperature sensor configured to produce the temperature input included with the RF transceiver circuitry.

20. The wireless device of claim 14, the processing circuitry further configured to service a financial transaction via the NFC interface.
